(19) United States
(12) Patent Application Publication
(10) Pub. No.: US 2026/0178065 A1
(43) Pub. Date: Jun. 25, 2026

(54) LOW QUIESCENT CURRENT LOW DROPOUT REGULATOR

(71) Applicant: Renesas Electronics America Inc., Milpitas, CA (US)

(72) Inventors: Anurag KAPLISH, San Jose, CA (US); Samyak PARAKH, Santa Clara, CA (US)

(73) Assignee: Renesas Electronics America Inc., Milpitas, CA (US)

(21) Appl. No.: 18/989,156

(22) Filed: Dec. 20, 2024

(51) Int. Cl. G05F 1/573; G05F 1/575

(52) U.S. Cl. CPC G05F 1/573; G05F 1/575

(57) ABSTRACT

Systems and integrated circuits for implementing a low quiescent current low-dropout (LDO) regulator are described. The system can include a super follower circuit, a current limit circuit and an LDO core circuit. The super follower circuit is configured to supply a first current. The current limit circuit is configured to receive a system input voltage and supply a second current. The LDO core circuit is coupled to the super follower circuit and the current limit circuit. The LDO core circuit is configured to receive the first current from the super follower circuit and the second current from the current limit circuit. The LDO core circuit is configured to supply and regulate a system output voltage at a system output node. The LDO core circuit can include a feedforward capacitor connected between the system output node and a feedback node.

### BACKGROUND

This disclosure generally relates to low dropout (LDO) voltage regulators. More particularly, this disclosure relates to low quiescent current low dropout regulators.

Low dropout (LDO) voltage regulators are critical components in electronic circuits, ensuring stable voltage supply under varying load and input voltage conditions. LDO applications span various fields, including automotive systems, consumer electronics, and industrial devices, where precise and efficient voltage regulation is useful.

The performance of LDO regulators is influenced by various factors, including current sourcing capabilities, load regulation, transient response, and thermal stability. Building blocks in LDO can include current limit circuits, feedback networks, and voltage reference paths, each contributing to optimizing the overall performance.

### SUMMARY

In an aspect, a system for implementing a low quiescent current low-dropout (LDO) regulator is generally described. The system can include a super follower circuit, a current limit circuit and an LDO core circuit. The super follower circuit is configured to supply a first current. The current limit circuit is configured to receive a system input voltage and supply a second current. The LDO core circuit is coupled to the super follower circuit and the current limit circuit. The LDO core circuit is configured to receive the first current from the super follower circuit and the second current from the current limit circuit. The LDO core circuit is configured to supply and regulate a system output voltage at a system output node. The LDO core circuit can include a feedforward capacitor connected between the system output node and a feedback node.

In an aspect, an integrated circuit for implementing a low quiescent current low-dropout (LDO) regulator is generally described. The integrated circuit can include a super follower circuit configured to supply a first current, a current limit circuit, and an LDO core circuit. The current limit circuit is configured to receive a system input voltage and supply a second current. The LDO core circuit is coupled to the super follower circuit and the current limit circuit. The LDO core circuit is configured to receive the first current from the super follower circuit and the second current from the current limit circuit. The LDO core circuit is configured to supply and regulate a system output voltage at a system output node. The LDO core circuit can include a sixth transistor, a fifth transistor, a fourth transistor, and a ninth transistor. The gate of the sixth transistor is connected to the system input voltage via a third resistor. The source of the sixth transistor is connected to a section output node of the current limit circuit. The drain of the sixth transistor is connected the system output node. The gate of the fifth transistor is connected to a drain of a first transistor. The drain of the fifth transistor is connected to the gate of the sixth transistor. The source of the fifth transistor is connected to ground via a third current source. The gate and the drain of the fourth transistor are connected to the gate of the fifth transistor. The source of the fourth transistor is connected to the ground via a fifth resistor and a sixth resistor. The gate and the drain of the ninth transistor are connected of the gate of the fifth transistor. The source of the ninth transistor is connected to a common node of the fifth resistor and the sixth resistor.

In an aspect, A system is generally described. The system can include a first LDO regulator and a second LDO regulator. The first LDO regulator is configured to work in a high voltage mode. The first LDO regulator is connected to a first rail to receive a first input voltage. The second LDO regulator is configured to work in a low voltage mode. The second LDO regulator is connected to a second rail to receive a second input voltage. The first input voltage is higher than the second input voltage. Either the first LDO or the second LDO provides an output voltage of the system.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram showing an example system for implementing low quiescent current LDO according to an illustrative embodiment.

FIG. 2 is a diagram showing an example system for implementing low quiescent current LDO according to an illustrative embodiment.

FIG. 3 illustrates a comparison of curves of impedance in the low voltage mode according to an illustrative embodiment.

FIG. 4 illustrates a comparison of curves of impedance in the high voltage mode according to an illustrative embodiment.

FIG. 5 illustrates an example system that integrates both a high voltage LDO and a low voltage LDO according to an illustrative embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, conventional structures or processing steps have not been described in detail in order to avoid obscuring the present application.

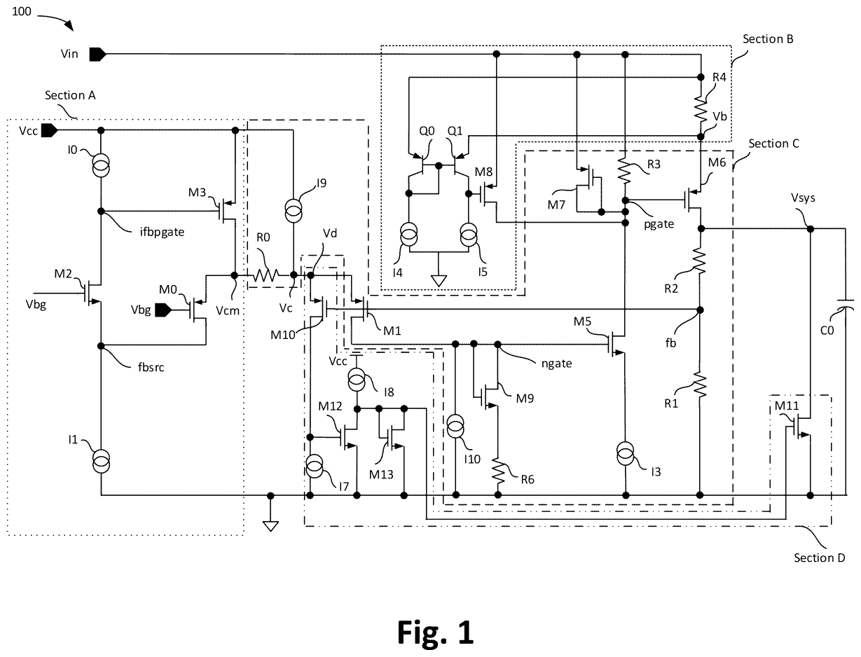

FIG. 1 is a diagram showing an example system 100 for implementing low quiescent current LDO according to an illustrative embodiment. As shown in FIG. 1, the system 100 can include Section A, Section B, Section C, and Section D. In this example, Section A is a super follower. Section B is a current limit circuit. Section C is the LDO core. Section D is a sink feedback loop. Note that there can be more or fewer sections in the system 100, and the configuration of circuits is for illustration purposes rather than limiting this disclosure.

### Section A

Section A (i.e., the super follower) is configured to supply a dynamic stage current to both Section C (i.e., the “LDO Core”) and Section D (i.e., the “Sink Feedback Loop”). The super follower maintains regulation of the voltage at the follower output node (referred to as Vcm) which is the common node of the third transistor M3 and the zeroth transistor M0 to the voltage Vbg+VSG0, where Vbg is the voltage input to the gate of the zeroth transistor and the gate of the second transistor, and VSG0 is the voltage difference between the source and the gate of the zeroth transistor M0. This regulation ensures proper current flow and voltage control through the system 100, contributing to the stability and efficiency of the overall circuit operation.

Section A can include a zeroth current source I0, a first current source I1, a zeroth transistor M0, a second transistor M2, and a third transistor M3. The input of the zeroth current source I0 is connected to a pull-up voltage Vcc, and the output of the zeroth current source I0 is connected to the gate of the third transistor M3 and the drain of the second transistor M2.

The input of the first current source I1 is connected to the source of the second transistor M2 and the drain of the zeroth transistor M0. The output of the first current source I1 is connected to the ground.

The gate of the zeroth transistor M0 is connected to a bandgap voltage Vbg. The source of the zeroth transistor M0 is connected to the drain of the third transistor M3 and one terminal of the zeroth resistor R0. In this example, the bandgap voltage Vbg is what is usually used for reference generation. In some instances, the bandgap voltage Vbg can be replaced with a reference voltage Vref (not shown). The drain of the zeroth transistor M0 is connected to the source of the second transistor M2.

The gate of the second transistor M2 is connected to Vbg. The drain of the second transistor M2 is connected to the output of the zeroth current source I0 and the gate of the third transistor M3. The source of the second transistor M2 is connected to input of the first current source I1 and the drain of the zeroth transistor M0.

The gate of the third transistor M3 is connected to the output of the zeroth current source I0 and the drain of the second transistor M2. The source of the third transistor M3 is connected to pull-up voltage Vcc. The drain of the third transistor M3 is connected to the source of the zeroth transistor M0.

During the operation of the super follower, the zeroth transistor M0 sinks current and functions as a common gate amplifier, alongside the second transistor M2. In this configuration, the source node of the zeroth transistor M0 features a common gate amplifier, where the signal remains non-inverted, meaning there is no phase change. Negative feedback is applied at the drain of the zeroth transistor M0. The common node between the zeroth transistor M0 and the second transistor is referred to as fbsrc. The phase change occurs at the third transistor M3, and the gate node of the third transistor M3 is referred to as ifbpgate.

The third transistor M3 is capable of sourcing a reasonable amount of current from the Follower output node Vcm via the negative feedback loop. For instance, if the source node Vcm of the zeroth transistor M0 becomes loaded with current, the voltage V_ifbsrc at the ifbsrc node decreases as the current increases. As a result, the current IM2 flowing through the second transistor M2 increases because V_ifbsrc drops while Vbg remains fixed. Accordingly, the voltage at the ifbpgate node, V_ifbpgate, decreases. This, in turn, causes the third transistor M3 to drive more current, which raises the voltage at the follower output node Vcm back up.

Additionally, if the voltage at the follower output node Vcm decreases, the current IM0 flowing through the zeroth transistor M0 decreases. As a result, the voltage at the feedback node ifbsrc (V_ifbsrc) will also decrease. This causes the current IM2 through the second transistor M2 to increase, which reduces the voltage at the ifbpgate node (V_ifbpgate), increasing the current IM3 flowing through the third transistor M3. This leads to an increase in the current at the follower output node Vcm. However, the current sinking into the follower output node Vcm is limited by the current source I1, meaning the current at the follower output node Vcm may not exceed I1.

### Section B

Section B is a current limit circuit configured to receive a system input voltage Vin and supply a second current at a section output node Vb. Section B can include a zeroth transistor Q0, a first transistor Q1, a fourth current source I4, a fifth current source I5, an eighth transistor M8, and a fourth resistor R4.

The base of the zeroth transistor Q0 and the base of first transistor Q1 are connected together to the collector of the zeroth transistor Q0. The emitter of the zeroth transistor Q0 is connected to the system input voltage Vin. The fourth resistor is connected between the emitter of the zeroth transistor Q0 and the emitter of the first transistor Q1. The fourth current source I4 is connected between the collector of the zeroth transistor Q0 and the ground. The fifth current source I5 is connected between the collector of the first transistor Q1 and the ground. The gate of the eighth transistor M8 is connected to the collector of the first transistor Q1. The source of the eighth transistor M8 is connected to the system input voltage Vin. The drain of the eighth transistor M8 is connected to the gate of M6 which is a part of Section C.

The fourth resistor R4 is configured to sense the current, where the current flowing through the fourth resistor R4 is determined by the voltage across the resistor R4. The current flowing through the fourth resistor R4 is primarily determined by the current through the sixth transistor M6, which includes the load current and the current flowing through the first resistor R1 and the second resistor R2. Assuming that the fourth current source I4 and the fifth current source I5 are negligible, the voltage across the fourth resistor R4 is predominantly generated by the current in the sixth transistor M6. For instance, the fourth resistor R4 is a metal resistor. Metals typically have a positive temperature coefficient, usually between 3000 and 4000 ppm/° C. (parts-per-million change in resistance per degree Celsius).

For example, if there is a mismatched base-to-emitter voltage Vbe (i.e., ΔVbe), represented as Vtln(N), the first transistor Q1 acts as an amplifier with a systematic offset of Vtln(N). This offset affects the current flowing through the eighth transistor M8. The amplifier Q1 starts limiting the current at Vtln(N)/R. Because the voltage Vt is proportional to temperature (Ptat), and the fourth resistor R4 also has a temperature-dependent coefficient, Vtln(N) is approximately matched to the temperature coefficient of metals such as copper or aluminum. Accordingly, a fixed current limit can be achieved. In another example, as the voltage at the emitter node of the first transistor Q1 decreases, the voltage at the gate node of the eighth transistor M8 also decreases. Acting as a common-base amplifier, the first transistor Q1 turns on the eighth transistor M8, pulling up the gate node pgate of the sixth transistor M6 and thereby limiting the current that can flow to the output.

### Section C

Section C is the LDO core coupled to both Section A and Section B. Section C can serve as the main part of the voltage regulator that regulates the voltage at the system output node (i.e., the input node of the output capacitor C0). Section C can be coupled to Section A, Section B, and Section D. For instance, the section input node Vc of Section C can be connected to the section output node Vcm of Section A via the zeroth resistor R0. Section C can include a first transistor M1, a fifth transistor M5, a sixth transistor M6, a seventh transistor M7, a ninth transistor M9, a first resistor R1, a second resistor R2, a third resistor R3, a sixth resistor R6, a ninth current source I9, a tenth current source I10, and a zeroth resistor R0.

The gate of the first transistor M1 is connected to a node between the first resistor R1 and the second resistor R2. The source of the first transistor M1 is connected to a common node of the output of the ninth current source I9 and the zeroth resistor R0. The drain of the first transistor M1 is connected to the gate of the fifth transistor M5. The drain of the fifth transistor M5 is connected to the gate of the sixth transistor M6. The source of the fifth transistor M5 is connected to the third current source I3.

The gate of the sixth transistor M6 is connected to a common node pgate of the third resistor R3 and the gate and drain of the seventh transistor M7. The source of the sixth transistor M6 is connected to the section output node Vb of Section B. The drain of the sixth transistor M6 is connected to the system output node Vsys. The gate and the drain of the seventh transistor are both connected to the pgate node. The source of the seventh transistor M7 is connected to the system input voltage Vin.

The gate and the drain of the ninth transistor M9 are connected to the ngate node. The source of the ninth transistor M9 is connected to the sixth resistor R6.

The first resistor R1 and the second resistor R2 are connected in series between the ground and the system output Vsys. The third resistor R3 is connected between the system input voltage Vin and the pgate node (i.e., the gate of the sixth transistor M6). The sixth resistor R6 is connected between the source of the ninth transistor M9 and the ground.

The ninth current source I9 is configured between the pull-up voltage Vcc and the source of the tenth transistor M10. The tenth current source I10 is connected between the ngate node (i.e., the gate of the fifth transistor M5) and ground. Additionally, the zeroth resistor R0 is placed between the follower output node of Section A (denoted as the Vcm in FIG. 1) and the section input node Vc of Section C, which is also the common node shared by the source of the first transistor M1 and the source of the tenth transistor M10.

During operation, the first transistor M1, the fifth transistor M5, and the sixth transistor M6 serve as common source amplifiers and collectively form a feedback path with gain. Each of the first transistor M1, the fifth transistor M5, and the sixth transistor M6 introduces a phase reversal, resulting in three phase reversals in this feedback loop, which characterizes it as a negative feedback path. Under light load conditions, the fifth transistor M5 and the sixth transistor M6 operate in deep sub-threshold mode, where the source-to-gate voltage (VSG) is below the threshold voltage (VTH), i.e., VSG<VTH. In this scenario, the ninth transistor M9 and the seventh transistor M7 are sized and configured to remain in the cutoff state, ensuring minimal influence on the circuit behavior. During light load operation, the impedance at the pgate node (i.e., the gate of the sixth transistor M6) is predominantly determined by the third resistor R3. The impedance at the ngate node is predominantly determined by the tenth current source I10. Accordingly, the poles are dominated by the third resistor at the pgate node and the tenth current source I10 at the ngate node.

As the current increases, the seventh transistor M7 and the ninth transistor M9 turn on, reducing the impedance at the pgate node (i.e., the gate of the sixth transistor M6) and at the ngate node (i.e., the gate of the fifth transistor M5). Under such conditions, when the load is heavy, both the fifth transistor M5 and the sixth transistor M6 operate in above threshold saturation. In this operating region, the gate-to-source voltage (VGS) of these devices is significantly higher than their threshold voltage (VTH), i.e., VGS>>VTH. When the seventh transistor M7 and the ninth transistor M9 conduct, they push the non-dominant poles of the system 100 to higher frequencies.

Moreover, as the load increases, the ninth transistor M9 turns on, and more current flows through the first transistor M1. For instance, as the current through the first transistor M1 changes, its source-to-gate voltage VSG1 adjusts accordingly. This happens because the increased current flow through the first transistor M1 alters the feedback node fb, causing its voltage to decrease and thereby driving more current through the first transistor M1. Accordingly, the source-to-gate voltage VSG1 of the first transistor M1 increases. As the current increases, an offset in the differential pair circuit arises, which is a drawback of the topology. If the ninth current source I9 were fixed (as in a typical differential pair), the imbalance would worsen. In such a scenario, the current through the zeroth transistor M0 would decrease while the current through the first transistor M1 would increase, eventually diverting all current to the right. However, the presence of a super follower (i.e., Section A) mitigates this issue. The source-to-gate voltage VSG0 of the zeroth transistor M0 remains constant because it is regulated by the zeroth current source I0 and the first current source I1. Specifically, the difference between the zeroth current source I0 and the first current source I1 determines the current flowing through the zeroth transistor M0. As the first transistor M1 demands more current, the third transistor M3 provides the additional current through the path of the first transistor M1 to the ninth transistor M9. This extra current is necessary to drive the sixth resistor R6, the ninth transistor M9, and the tenth current source I10. This current flow is maintained via the super follower in Section A, ensuring proper operation and stability of the system 100.

The operation of the third current source I3 can be illustrated with the following example. The third current source I3 may be implemented as a transistor, while the fifth transistor M5 functions as a common source amplifier. When the current flowing through the fifth transistor M5 is relatively low, the transistor at the third current source I3 operates in the linear region. As the voltage at the ngate node (i.e., the gate of the fifth transistor M5) increases, the voltage at the source of the fifth transistor M5 also rises. Eventually, the transistor at I3 transitions from the linear region to saturation.

Once in saturation, the third current source I3 reaches its maximum current limit. At this point, the current flowing through the fifth transistor M5 is constrained by the capacity of I3 rather than the properties of M5. This behavior prevents excessive current through M5 and stabilizes the current in the circuit.

Once the transistor at third current source I3 is in saturation, it reaches a limit in the current it can supply, as the third current source I3 is current-driven. At this point, the current flowing through the fifth transistor M5 is determined by the maximum current capacity of third current source I3 rather than the characteristics of the fifth transistor M5 itself. Accordingly, the current at the pgate node (i.e., the gate of the sixth transistor M6) becomes fixed, preventing further increases. This limits the maximum current through the fifth transistor M5, ensuring that the eighth transistor M8 does not need to supply an excessive amount of current to compensate when M5 reaches its current limit. Thus, as the load increases, the third current source I3 effectively restricts the maximum current in the path through the fifth transistor M5 and constrains the current that the eighth transistor M8 must provide, ensuring stable operation in the current limit state.

Additionally, Safe Operating Area (SOA) issues may arise with the sixth transistor M6. For example, if excessive current flows through the path involving the fifth transistor M5, the source-to-gate voltage VSG7 of the seventh transistor M7 could become dangerously high, potentially damaging the gate of M7. To mitigate this, the seventh transistor M7 can act as a diode, clamping the gate of the sixth transistor M6 to a safe value, thereby preventing damage to both the sixth transistor M6 and the seventh transistor M7. For instance, the source-to-gate voltage VSG6 of the sixth transistor M6 can be clamped to a value below 5.5V (i.e., VSG6<5.5V). This mechanism not only safeguards the circuit but also ensures that the quiescent current remains within a reasonable range when the low dropout regulator (LDO) operates in current limit or dropout mode.

### Section D

Section D is a sink feedback loop configured to stabilize the system output voltage. Section D is coupled to Section A and Section C. For instance, the section input node Vd can be connected to the section output node Vcm of Section A via the zeroth resistor R0. The section input node Vd can also be connected to the section input node Vc of Section C. Section D can include a tenth transistor M10, an eleventh transistor M11, a twelfth transistor M12, a thirteenth transistor M13, a seventh current source I7, and an eighth current source I8.

The gate of the tenth transistor M10 is connected to the feedback node fb, while its source is connected to the common node shared by the ninth current source I9 and the zeroth resistor R0. The gate of the eleventh transistor M11 is connected to the common node of the twelfth transistor M12 and the thirteenth transistor M13. The drain of the eleventh transistor M11 is connected to the system output Vsys, and its source is grounded. The gate of the twelfth transistor M12 is connected to the drain of the tenth transistor M10 and to the input of the seventh current source I7. The drain of the twelfth transistor M12 is connected to the output of the eighth current source I8, while its source is grounded. The gate and drain of the thirteenth transistor M13 are connected to the output of the eighth current source I8, and its source is grounded. The seventh current source I7 is positioned between the gate of the twelfth transistor M12 and the ground. The eighth current source I8 is connected between the pull-up voltage (Vcc) and the common node shared by the twelfth transistor M12 and the thirteenth transistor M13.

For instance, in an automotive application, an elevated temperature may cause the sixth transistor M6 to leak tens of microamps of current. Given that the first resistor R1 and the second resistor R2 have relatively high resistance values—consistent with the design of system 100 as a low-quiescent-current LDO—this leakage current can lead to a significant rise in the voltage at the system output Vsys (i.e., the input node of the output capacitor C0). This elevated voltage is problematic, as it directly supplies the internal Vcc of downstream load circuits connected to the system output Vsys, while the downstream load circuits are typically designed to tolerate a maximum of 5.5 volts. Accordingly, the leakage of the sixth transistor M6 can produce an excessive current to potentially damage these load circuits, making such a scenario unacceptable.

To mitigate such damaging scenarios, a pull-down path involving M11 can be implemented. Additionally, the tenth transistor M10 is included in parallel with the first transistor M1. For example, the tenth transistor M10 can be configured with a different size than M1, typically larger. When the output voltage at the system output Vsys exceeds the regulation point of the tenth transistor of M10, the voltage at the feedback node fb rises, causing the tenth transistor M10 to turn off. Accordingly, the twelfth transistor M12 also turns off, resulting in an increase in the voltage at the drain node of the twelfth transistor M12. This occurs because the eighth current source I8 drives current into the thirteenth transistor M13, which functions as a diode. The current through the thirteenth transistor M13 is mirrored at the eleventh transistor M11, thereby creating a negative feedback path in Section D, slightly offset to activate at higher voltages than the feedback path of M1.

As a result, during operation, the system 100 does not actively push or pull current via Section D. Instead, Section D only activates when the output voltage rises above the normal regulation point, enabling Section D to pull current. Along the feedback path, the voltage divider made of the first resistor R1 and the second resistor R2 interacts with the tenth transistor M10, which functions as a common source amplifier and introduces one signal inversion. Similarly, the twelfth transistor M12 and the eleventh transistor M11 also act as common source amplifiers, each contributing one inversion, thereby establishing a negative feedback loop in Section D.

Furthermore, the twelfth transistor M12 is stabilized by its connection to the thirteenth transistor M13, which serves as a diode, effectively limiting the impedance at the drain node of the twelfth transistor M12. This stabilization ensures reliable operation during leakage events, particularly under high-temperature conditions, by allowing Section D to pull down the current as needed.

Additionally, Section D offers significant advantages during load release. For example, when the output load transitions from a high current to a low current, the system output Vsys may experience a sudden voltage spike followed by a gradual decay. In such cases, the eleventh transistor M11 activates to facilitate a faster voltage drop at the system output Vsys. Specifically, during load transients, the feedback loop of Section D accelerates the response to changes when the load current decreases, helping the LDO to operate efficiently in both high-voltage and low-voltage modes.

In one example, the performance of system 100 may degrade at high temperatures if there is no Section D, particularly in the absence of a coupled load. Without a load, the sixth transistor M6 may experience current leakage, causing the output voltage to rise to a level that could potentially damage downstream load circuits. While this leakage may not pose a significant issue at lower temperatures, it becomes problematic as the temperature increases. When the voltage at the feedback node fb rises high enough, the tenth transistor M10 turns off, thereby activating the sink feedback loop (i.e., Section D). This sink feedback loop helps the system 100 to sink current from the system output Vsys via M11, preventing excessive voltage buildup.

It should be noted that Section D can be omitted from system 100 without compromising the proper functioning of the remaining components when a load is coupled to the system output Vsys. Therefore, Section D is optional.

The operation of system 100 can be influenced by variations in the load. For instance, as the load changes, the bias point of the first transistor M1 shifts, causing a corresponding change in the current flowing through M1. The Super Follower in Section A compensates for these changes to maintain stability. However, one limitation of system 100 is that the impedance at the gate of M5 may not adjust at the same rate as the load increases, which can adversely affect the stability of the device and degrade overall performance. Additionally, as the load varies, the output impedance and the bias point of the sixth transistor M6 also change. To address this, the ninth transistor M9 and the seventh transistor M7, configured as diode-connected transistors, are utilized to shift the remaining poles in alignment with the dominant pole as the load fluctuates. While this approach partially mitigates the effects of pole movement on stability, there remains a need for further improvements to enhance overall performance of the system 100.

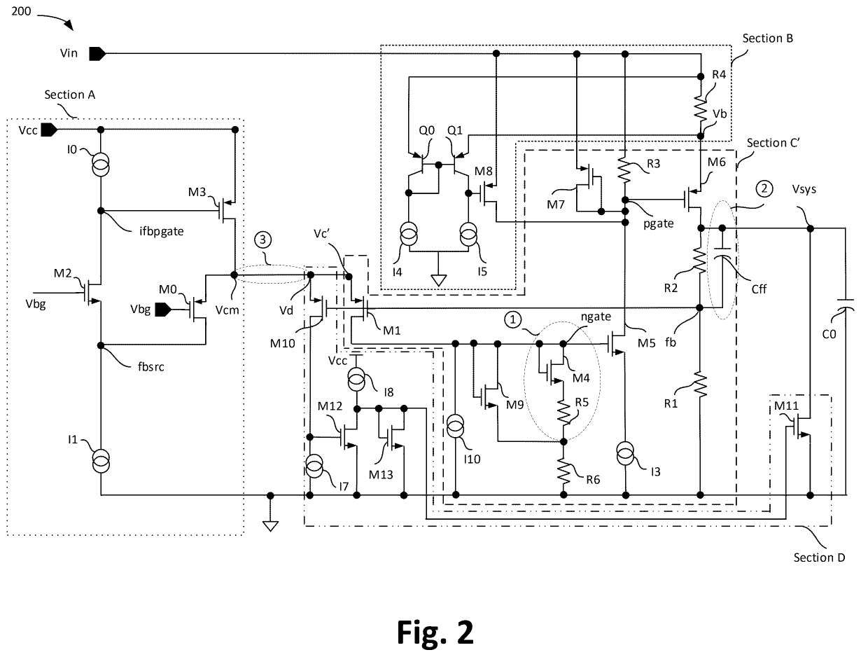

FIG. 2 is a diagram showing an example system 200 for implementing low quiescent current LDO according to an illustrative embodiment. In this embodiment, the same components in system 200 as in system 100 from FIG. 1 are represented by the same reference numbers. Referring to FIG. 2, the system 200 can include Section A, Section B, Section C′, and Section D. Section A is a super follower. Section B is a current limit circuit. Section C′ is the LDO core. Section D is a sink feedback loop. Note that there can be more or fewer sections in the system 200, and the configuration of circuits is for illustration purposes rather than limiting this disclosure. In this example, Sections A, B, and D in FIG. 2 have the same structure and operate in the same manner as those in the system 100 shown in FIG. 1.

Additionally, Section C′ in the system 200 incorporates three changes compared to Section C in system 100, which are referred to as Change 1, Change 2, and Change 3. These three changes collectively improve the performance of the system 200, providing enhanced regulation, stability, and efficiency compared to the configuration in system 100. Additional details are provided below.

### Change 1

Change 1 involves the addition of a fourth transistor M4 and a fifth resistor R5, connected in series between the ngate node and the sixth resistor R6. This change introduces an additional path for current regulation, influencing the impedance characteristics at the ngate node.

The addition of the fourth transistor M4, which has a shorter channel than the ninth transistor M9, introduces a systematic difference in threshold voltage VTH between the fourth transistor M4 and the ninth transistor M9. This difference plays a role as the output load increases. For instance, the fourth transistor M4 turns on, limiting the impedance at the ngate node of the fifth transistor M5. As the load current rises further, the ninth transistor M9 turns on and continues to reduce the impedance. This sequential activation of the fourth transistor M4 and the ninth transistor M9 ensures the impedance at the gate node ngate of the fifth transistor M5 continues to decrease with increasing load current.

Change 1 allows modification of the ngate impedance by using a combination of a long-channel transistor M9 and a short-channel transistor M4 pairs. This approach effectively reduces the gain of the main regulation loop as the load increases, thereby enhancing the stability and performance of the system 200 under varying conditions. In practice, the channel length of the short-channel transistor M4 can be approximately one-third of the channel length of the long-channel transistor M9. For instance, the ninth transistor M9 can have a channel length of 1.5 μm (LM9=1.5 μm), while the fourth transistor M4 can have a channel length of 0.5 μm (LM4=0.5 μm). The corresponding resistor values can be R5=296 kΩ, and R6=890 kΩ. Note that these values are exemplary rather than limiting, and other values can be used based on circumstances.

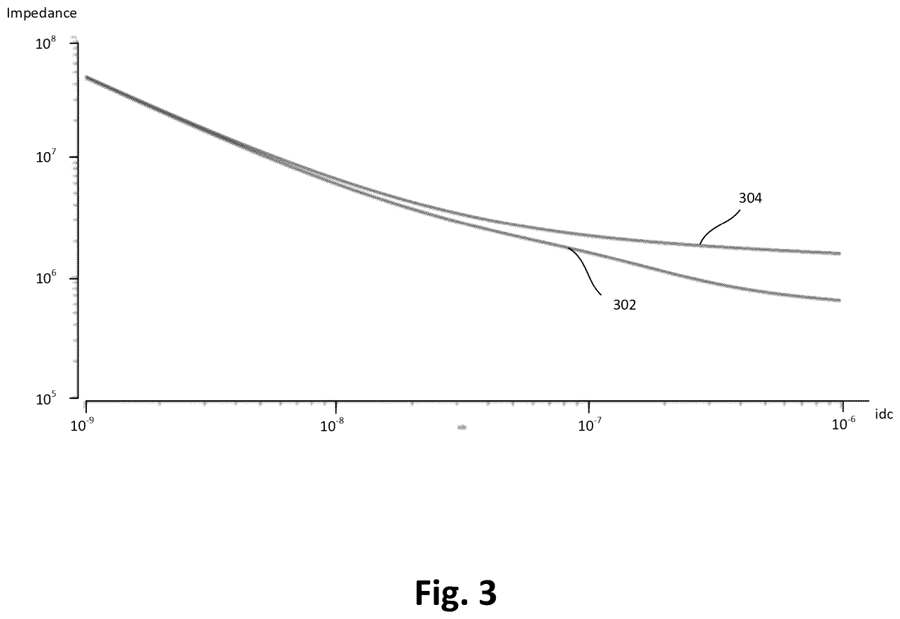

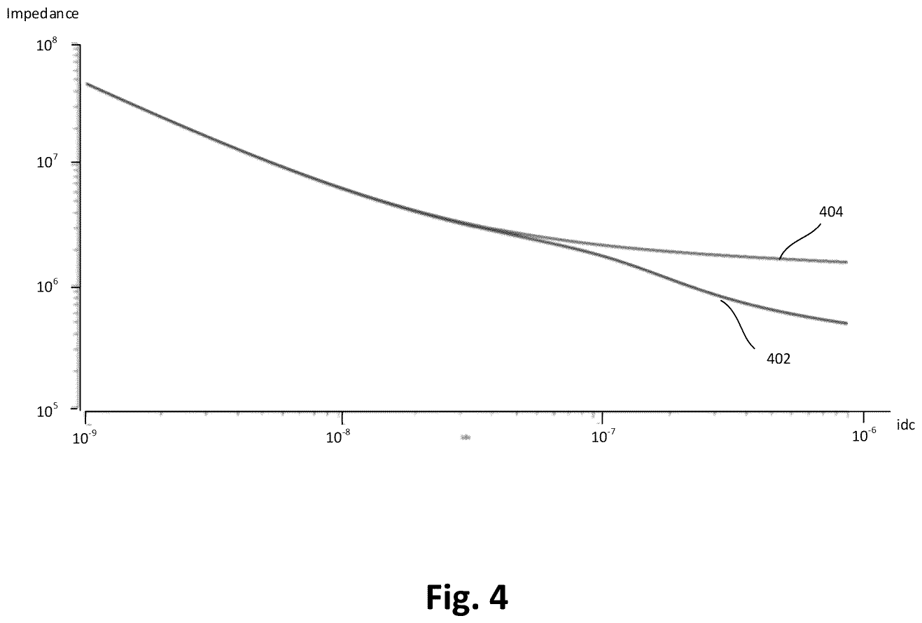

The shorter channel length of the fourth transistor M4 results in a lower threshold voltage Vth compared to the longer channel length of the ninth transistor M9. Additionally, variations in the width-to-length ratio (W/L) between the fourth transistor M4 and the ninth transistor M9 influence the point at which the long-channel leg (M9) begins to turn on. Together, these effects allow for dynamic variation of the resistance at the gate of the fifth transistor M5 in response to load changes, as demonstrated in FIG. 3 and FIG. 4. This dynamic adjustment contributes to improved regulation and enhanced circuit efficiency across a wide range of load conditions.

### Change 2

Change 2 introduces a feedforward capacitor Cff, connected between the system output Vsys and the feedback node fb. The addition of the feedforward capacitor Cff can counteract the pole that arises at the feedback node fb, which is primarily due to the parasitic capacitance and the resistor divider (including the first resistor R1 and the second resistor R2) at the feedback node fb.

The feedforward capacitor Cff serves to balance the pole, addressing a limitation in the topology in the system 100 shown in FIG. 1, where the poles were constrained to track with the output. In the topology in the system 100, as the load current changes, the poles shift in a manner consistent with the load, but the parasitic pole at the feedback node fb does not move. By adding the feedforward capacitor Cff, the system 200 compensates for this issue preventing potential instability.

The stability of the system 200 is influenced by several poles and zeros. The dominant pole is determined by the combination of the output capacitance (Cout) and the load resistance (Rload). In addition, there are several high-frequency poles generated by parasitic capacitances across various transistors in the system. For example, the poles can include a first pole at the gate of the first transistor M1 due to parasitic capacitance Ceff_fb and the effective resistance Reff_fb at the feedback node fb, a second pole at the gate of the fifth transistor M5 due to the parasitic capacitance Ceff_ngate and the effective resistance Reff_ngate, and a third high-frequency pole generated by the parasitic capacitance Ceff_pgate at the gate of the third transistor M3 and the effective resistance Reff_pgate at that node.

Furthermore, the feedforward capacitor Cff introduces a zero and an additional pole. For instance, a first high-frequency zero is introduced by the second resistor R2 and the feedforward capacitor Cff. The first high-frequency zero partially compensates for the effect of the first high-frequency pole, improving circuit stability. A fourth high-frequency pole is created by the combination of R1∥R2 and the feedforward capacitor Cff. The zero created by feedforward capacitor Cff and the second resistor R2 coincides with the pole at the gate of the first transistor M1. This helps compensate for the pole at the gate of the first transistor M1, allowing the system 200 to maintain stability even as the load current increases.

### Change 3

Change 3 removes the zeroth resistor R0, which was previously located between the follower output node Vcm and the section input node Vc of Section C. By eliminating this resistor R0, the system 200 reduces unwanted resistance that could impact the accuracy of voltage regulation. Additionally, the nineth current source I9 can also be removed due to the removal of the zeroth resistor R0. Accordingly, the section output node Vcm of Section A is connected directly to the section input node Vc′ (i.e., the source of the first transistor M1) of Section C′.

Change 3 involves the removal of the zeroth resistor R0 that is used in the system 100 shown in FIG. 1 to limit the maximum transconductance (GM) of the first transistor M1. The zeroth resistor R0 was originally added to prevent the bandwidth from becoming excessively high, which could lead to instability. However, with the introduction of the feedforward capacitor Cff in Change 2, the first high-frequency pole was sufficiently compensated for, allowing for the removal of this zeroth resistor R0. The removal of the zeroth resistor R0 brings two benefits. That is, first, it increases the bandwidth of the circuit, improving the transient response, and second, it enables higher current to flow through the first transistor M1 and the fourth transistor M4, making the system 200 more suitable for larger loads.

The first benefit, an increase in bandwidth, directly enhances the ability of the system 200 to respond to fast transient events, improving the overall performance. With a wider bandwidth, the system 200 can operate more efficiently under varying load conditions. The second benefit is the ability to push more current through the first transistor M1 and the fourth transistor M4, which improves the load current handling capability of the system 200. The removal of the zeroth resistor R0 ensures that the system 200 can accommodate larger loads without compromising stability.

Change 1 can be simulated in two different LDO modes, one for high voltage mode and the other for low voltage mode. FIG. 3 illustrates a comparison of curves of impedance in the low voltage mode according to an illustrative embodiment. FIG. 4 illustrates a comparison of curves of impedance in the high voltage mode according to an illustrative embodiment.

Referring to FIG. 1 and FIG. 2, across Section A, Section B, Section C, and Section D, the zeroth transistor M0, the first transistor M1, the second transistor M2, the third transistor M3, the fourth transistor M4, the fifth transistor M5, the sixth transistor M6, the seventh transistor M7, the eighth transistor M8, the ninth transistor M9, the tenth transistor M10, the eleventh transistor M11, the twelfth transistor M12, and the thirteenth transistor M13 can be implemented as metal-oxide-semiconductor field-effect (MOSFET) transistors. More particularly, the zeroth transistor M0, the first transistor M1, the third transistor M3, the sixth transistor M6, the seventh transistor M7, the eighth transistor M8, and the tenth transistor M10 can be implemented as p-gate MOSFET transistors. Meanwhile, the second transistor M2, the fourth transistor M4, the fifth transistor M5, the ninth transistor M9, the eleventh transistor M11, the twelfth transistor M12, and the thirteenth transistor M13 can be implemented as n-gate MOSFET transistors. Note that other types of transistors can be used in various scenarios.

Referring to FIG. 3, in this example, curve 302 represents the impedance at the gate node ngate of the fifth transistor M5 in the system 200 when the system 200 is working in a low voltage mode. Curve 304 shows at the gate node ngate of the fifth transistor M5 in the system 100. The horizontal axis represents the current idc, and the vertical axis represents the impedance at the gate node ngate of the fifth transistor M5.

In this example, the fourth transistor M4 and the fifth resistor R5 are placed in parallel with the ninth transistor M9 in the system 200 shown in FIG. 2, creating an additional current path. For instance, the fourth transistor M4 may have a shorter channel compared to the ninth transistor M9, and thus, the fourth transistor M4 activates earlier than the ninth transistor M9, allowing for a reduction in impedance at a lower load current. Compared to the configuration of system 100 shown in FIG. 1, relying solely on the ninth transistor M9, which reduces impedance up to a certain point limited by the sixth resistor R6, the addition of the fourth transistor M4 allows for a more gradual decrease in impedance as the load current increases. In this example, the fourth transistor M4 begins to reduce the impedance at the ngate node at a first current IDC1. When the ninth transistor M9 turns on later at a second current IDC2, it continues reducing the impedance at the ngate node, maintaining a steady decrease in impedance over a larger load current range.

Referring to FIG. 4, curve 402 represents the impedance at the gate node ngate of the fifth transistor M5 in the system 200 when the system 200 is working in a high voltage mode. Curve 404 shows the impedance at the gate node ngate of the fifth transistor M5 in the system 100. In this example, curve 402 shows that as the load current increases, the fourth transistor M4 reduces the impedance at a third current IDC3 when it turns on, and the ninth transistor M9 further reduces the impedance at a fourth current IDC4 when it turns on. The result of curve 402 shows a more stable and efficient LDO that operates effectively across a wider range of load currents compared to curve 404.

In this example, curve 402 represents the impedance at the gate node ngate of the fifth transistor M5 in the system 200 when the system 200 is working in a high voltage mode. Curve 404 shows at the gate node ngate of the fifth transistor M5 in the system 100.

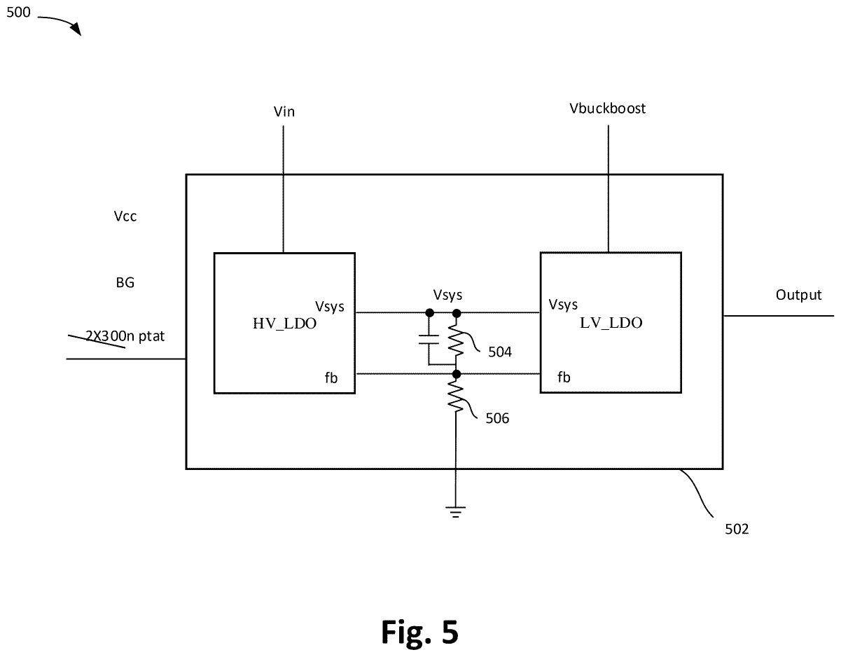

FIG. 5 illustrates an example system 500 that integrates both a high voltage LDO and a low voltage LDO according to an illustrative embodiment. In this example, each of the HV_LDO and the LV_LDO can be implemented using the system 200 shown in FIG. 2.

The system 500 allows operation across a wide input voltage range while delivering a stable output, e.g., 5V. As described above, the system 200 as shown in FIG. 2, can function as either a high-voltage (HV) or low-voltage (LV) regulator. FIG. 5 illustrates a combined configuration that integrates an HV_LDO and an LV_LDO into a single block 502. The block 502 can operate using input supplies from a high-voltage rail Vin (e.g., ranging from 5.6 to 45V) and a low-voltage buck-boost rail Vbuckboost (e.g., at 5.7V). The block 502 can provide a stable regulated output voltage Vsys (e.g., at 5V). The two LDOs (i.e., the HV_LDO and the LV_LDO) are connected in parallel and share a common resistive divider network which may include a seventh resistor 504 and an eighth resistor 506. Bias inputs to the block 502 can include bandgap voltage (BG voltage), VCC, and two PTAT currents (e.g., each of which is 300 nA).

The two LDOs (i.e., the HV_LDO and the LV_LDO) are combined into a single output, with one being selected based on the availability of the buck-boost supply. In other words, either the HV_ LDO or the LV_ LDO provides the output voltage of the system. As an example, when the product powers on, the HV_LDO initially activates to bring the output voltage Vsys up to the target voltage such as 5V. Vin initially drives the output voltage Vsys, providing the supply for the internal circuitry. This supply activates the circuitry responsible for operating the buck-boost converter, which generates a lower voltage. Once the buck-boost rail (e.g., at 5.7V) is ready, the LV_LDO takes over regulation duties, automatically disabling the HV_LDO. Such a configuration reduces power dissipation during operation. The HV_LDO, which handles high input voltages (Vin ranging from e.g., 5.6 to 45V), can experience significant power loss due to the large voltage drop across the pass device. By transitioning to the LV_LDO, which operates at a much lower voltage, overall power dissipation is minimized. This transition improves the efficiency of the product while maintaining reliable and sustained operation.

### EXAMPLES

### Example 1

A system for implementing a low quiescent current low-dropout (LDO) regulator, comprising: a super follower circuit configured to supply a first current; a current limit circuit configured to receive a system input voltage and supply a second current; and an LDO core circuit coupled to the super follower circuit and the current limit circuit, the LDO core circuit being configured to receive the first current from the super follower circuit and the second current from the current limit circuit, the LDO core circuit being configured to supply and regulate a system output voltage at a system output node, wherein the LDO core circuit comprises a feedforward capacitor connected between the system output node and a feedback node.

### Example 2

The system of Example 1 further comprising a sink feedback loop coupled to the LDO core circuit and the super follower, the sink feedback loop being configured to stabilize the system output voltage.

### Example 3

The system of any one of Examples 1 and 2, wherein the current limit circuit is further configured to regulate the second current based on temperature.

### Example 4

The system of any one of Examples 1 to 3, wherein the LDO core circuit comprises: a sixth transistor, a gate of the sixth transistor being connected to the system input voltage via a third resistor, a source of the sixth transistor being connected to a section output node of the current limit circuit, a drain of the sixth transistor being connected the system output node; a fifth transistor, a gate of the fifth transistor being connected to a drain of a first transistor, a drain of the fifth transistor being connected to the gate of the sixth transistor, a source of the fifth transistor being connected to ground via a third current source; a fourth transistor, a gate and a drain of the fourth transistor being connected to the gate of the fifth transistor, a source of the fourth transistor being connected to the ground via a fifth resistor and a sixth resistor; and a ninth transistor, a gate and a drain of the ninth transistor being connected of the gate of the fifth transistor, a source of the ninth transistor being connected to a common node of the fifth resistor and the sixth resistor.

### Example 5

The system of any one of Examples 1 to 4, wherein the fourth transistor has a first channel length, and the ninth transistor has a second channel length; and wherein the first channel length is smaller than the second channel length.

### Example 6

The system of any one of Examples 1 to 5, wherein first channel length is one third of the second channel length.

### Example 7

The system of any one of Examples 1 to 6, wherein a follower output node of the super follower circuit is directly connected to a section input node of the LDO core circuit.

### Example 8

An integrated circuit for implementing a low quiescent current low-dropout (LDO) regulator, comprising: a super follower circuit configured to supply a first current; a current limit circuit configured to receive a system input voltage and supply a second current; and an LDO core circuit coupled to the super follower circuit and the current limit circuit, the LDO core circuit being configured to receive the first current from the super follower circuit and the second current from the current limit circuit, the LDO core circuit being configured to supply and regulate a system output voltage at a system output node, the LDO core circuit comprising: a sixth transistor, a gate of the sixth transistor being connected to the system input voltage via a third resistor, a source of the sixth transistor being connected to a section output node of the current limit circuit, a drain of the sixth transistor being connected the system output node; a fifth transistor, a gate of the fifth transistor being connected to a drain of a first transistor, a drain of the fifth transistor being connected to the gate of the sixth transistor, a source of the fifth transistor being connected to ground via a third current source; a fourth transistor, a gate and a drain of the fourth transistor being connected to the gate of the fifth transistor, a source of the fourth transistor being connected to the ground via a fifth resistor and a sixth resistor; and a ninth transistor, a gate and a drain of the ninth transistor being connected of the gate of the fifth transistor, a source of the ninth transistor being connected to a common node of the fifth resistor and the sixth resistor.

### Example 9

The integrated circuit of Example 8 wherein the LDO core circuit comprises a feedforward capacitor connected between the system output node and a feedback node.

### Example 10

The integrated circuit of any one of Examples 8 and 9, wherein the feedback node is a common node of a first resistor and a second resistor, the first resistor and the second resistor being connected in series between ground and the drain of the sixth transistor.

### Example 11

The integrated circuit of any one of Examples 8 to 10, further comprising a sink feedback loop connected between the system output node and the super follower circuit, the sink feedback loop being configured to stabilize the system output voltage.

### Example 12

The integrated circuit of any one of Examples 8 to 11, wherein the current limit circuit is further configured to regulate the second current based on temperature.

### Example 13

The integrated circuit of any one of Examples 8 to 12, wherein the current limit circuit comprises a fourth resistor configured to sense a current associated with the temperature.

### Example 14

The integrated circuit of any one of Examples 8 to 13, wherein the fourth transistor has a first channel length, and the ninth transistor has a second channel length; and wherein the first channel length is smaller than the second channel length.

### Example 15

The integrated circuit of any one of Examples 8 to 14, wherein the first channel length is one third of the second channel length.

### Example 16

The integrated circuit of any one of Examples 8 to 15, wherein a follower output node of the super follower circuit is directly connected to a section input node of the LDO core circuit.

### Example 17

A system comprising: a first low-dropout (LDO) regulator configured to work in a high voltage mode, the first LDO regulator being connected to a first rail to receive a first input voltage; and a second LDO regulator configured to work in a low voltage mode, the second LDO regulator being connected to a second rail to receive a second input voltage, the first input voltage being higher than the second input voltage, wherein either the first LDO or the second LDO provides an output voltage of the system.

### Example 18

The system of Example 17 wherein the first LDO is further configured to provide the output voltage when the system is powered on.

### Example 19

The system of any one of Examples 17 and 18, wherein the second LDO is further configured to provide the output voltage when the second input voltage is available.

### Example 20

The system of any one of Examples 17 to 19, wherein each one of the first LDO and the second LDO comprises an integrated circuit comprising: a super follower circuit configured to supply a first current; a current limit circuit configured to receive a system input voltage and supply a second current; and an LDO core circuit coupled to the super follower circuit and the current limit circuit, the LDO core circuit being configured to receive the first current from the super follower circuit and the second current from the current limit circuit, the LDO core circuit being configured to supply and regulate a system output voltage at a system output node.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting to the present disclosure. As used herein, the singular forms “a”, “an” and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present disclosure have been presented for purposes of illustration and description but are not intended to be exhaustive or limited to the embodiments in the forms disclosed. Many modifications and variations will be apparent to those of ordinary skill in the art without departing from the scope and spirit of the present disclosure. The embodiments were chosen and described in order to best explain the principles of the present disclosure and the practical application, and to enable others of ordinary skill in the art to understand the present disclosure for various embodiments with various modifications as are suited to the particular use contemplated.

What is claimed is:

1. A system for implementing a low quiescent current low-dropout (LDO) regulator, comprising:
a super follower circuit configured to supply a first current;
a current limit circuit configured to receive a system input voltage and supply a second current; and
an LDO core circuit coupled to the super follower circuit and the current limit circuit, the LDO core circuit being configured to receive the first current from the super follower circuit and the second current from the current limit circuit, the LDO core circuit being configured to supply and regulate a system output voltage at a system output node,
wherein the LDO core circuit comprises a feedforward capacitor connected between the system output node and a feedback node.

2. The system of claim 1, further comprising a sink feedback loop coupled to the LDO core circuit and the super follower, the sink feedback loop being configured to stabilize the system output voltage.

3. The system of claim 1,
wherein the current limit circuit is further configured to regulate the second current based on temperature.

4. The system of claim 3, wherein the LDO core circuit comprises:
a sixth transistor, a gate of the sixth transistor being connected to the system input voltage via a third resistor, a source of the sixth transistor being connected to a section output node of the current limit circuit, a drain of the sixth transistor being connected the system output node;
a fifth transistor, a gate of the fifth transistor being connected to a drain of a first transistor, a drain of the fifth transistor being connected to the gate of the sixth transistor, a source of the fifth transistor being connected to ground via a third current source;
a fourth transistor, a gate and a drain of the fourth transistor being connected to the gate of the fifth transistor, a source of the fourth transistor being connected to the ground via a fifth resistor and a sixth resistor; and
a ninth transistor, a gate and a drain of the ninth transistor being connected of the gate of the fifth transistor, a source of the ninth transistor being connected to a common node of the fifth resistor and the sixth resistor.

5. The system of claim 4,
wherein the fourth transistor has a first channel length, and the ninth transistor has a second channel length; and
wherein the first channel length is smaller than the second channel length.

6. The system of claim 5, wherein first channel length is one third of the second channel length.

7. The system of claim 1,
wherein a follower output node of the super follower circuit is directly connected to a section input node of the LDO core circuit.

8. An integrated circuit for implementing a low quiescent current low-dropout (LDO) regulator, comprising:
a super follower circuit configured to supply a first current;
a current limit circuit configured to receive a system input voltage and supply a second current; and
an LDO core circuit coupled to the super follower circuit and the current limit circuit, the LDO core circuit being configured to receive the first current from the super follower circuit and the second current from the current limit circuit, the LDO core circuit being configured to supply and regulate a system output voltage at a system output node, the LDO core circuit comprising:
a sixth transistor, a gate of the sixth transistor being connected to the system input voltage via a third resistor, a source of the sixth transistor being connected to a section output node of the current limit circuit, a drain of the sixth transistor being connected the system output node;
a fifth transistor, a gate of the fifth transistor being connected to a drain of a first transistor, a drain of the fifth transistor being connected to the gate of the sixth transistor, a source of the fifth transistor being connected to ground via a third current source;
a fourth transistor, a gate and a drain of the fourth transistor being connected to the gate of the fifth transistor, a source of the fourth transistor being connected to the ground via a fifth resistor and a sixth resistor; and
a ninth transistor, a gate and a drain of the ninth transistor being connected of the gate of the fifth transistor, a source of the ninth transistor being connected to a common node of the fifth resistor and the sixth resistor.

9. The integrated circuit of claim 8,
wherein the LDO core circuit comprises a feedforward capacitor connected between the system output node and a feedback node.

10. The integrated circuit of claim 9,
wherein the feedback node is a common node of a first resistor and a second resistor, the first resistor and the second resistor being connected in series between ground and the drain of the sixth transistor.

11. The integrated circuit of claim 8, further comprising a sink feedback loop connected between the system output node and the super follower circuit, the sink feedback loop being configured to stabilize the system output voltage.

12. The integrated circuit of claim 8,
wherein the current limit circuit is further configured to regulate the second current based on temperature.

13. The integrated circuit of claim 12,
wherein the current limit circuit comprises a fourth resistor configured to sense a current associated with the temperature.

14. The integrated circuit of claim 8,
wherein the fourth transistor has a first channel length, and the ninth transistor has a second channel length; and
wherein the first channel length is smaller than the second channel length.

15. The integrated circuit of claim 14, wherein the first channel length is one third of the second channel length.

16. The integrated circuit of claim 8, wherein a follower output node of the super follower circuit is directly connected to a section input node of the LDO core circuit.

17. A system comprising:
a first low-dropout (LDO) regulator configured to work in a high voltage mode, the first LDO regulator being connected to a first rail to receive a first input voltage; and
a second LDO regulator configured to work in a low voltage mode, the second LDO regulator being connected to a second rail to receive a second input voltage, the first input voltage being higher than the second input voltage,
wherein either the first LDO or the second LDO provides an output voltage of the system.

18. The system of claim 17,
wherein the first LDO is further configured to provide the output voltage when the system is powered on.

19. The system of claim 17,
wherein the second LDO is further configured to provide the output voltage when the second input voltage is available.

20. The system of claim 17,
wherein each one of the first LDO and the second LDO comprises an integrated circuit comprising:
a super follower circuit configured to supply a first current;
a current limit circuit configured to receive a system input voltage and supply a second current; and
an LDO core circuit coupled to the super follower circuit and the current limit circuit, the LDO core circuit being configured to receive the first current from the super follower circuit and the second current from the current limit circuit, the LDO core circuit being configured to supply and regulate a system output voltage at a system output node.
